(19) United States
(12) Patent Application Publication
(10) Pub. No.: US 2013/0140362 A1
(43) Pub. Date: Jun. 6, 2013

(54) ELECTRICAL PRODUCT

(71) Applicant: MURATA MANUFACTURING CO., LTD., Nagaokakyo-shi (JP)

(72) Inventors: Ikuhei KIMURA, Nagaokakyo-shi (JP); Noboru KATO, Nagaokakyo-shi (JP); Tsutomu IEKI, Nagaokakyo-shi (JP)

(73) Assignee: MURATA MANUFACTURING CO., LTD., Nagaokakyo-shi (JP)

(21) Appl. No.: 13/757,991

(22) Filed: Feb. 4, 2013

Related U.S. Application Data
(63) Continuation of application No. PCT/JP2011/074009, filed on Oct. 19, 2011.

(30) Foreign Application Priority Data
Dec. 1, 2010 (JP) 2010-268252

(51) Int. Cl. G06K 19/07

(52) U.S. Cl. CPC G06K 19/0723
USPC 235/439; 235/492

(57) ABSTRACT

A wireless IC device processing a high-frequency signal is arranged in an electrical product main body, and an input-output terminal of the wireless IC device is coupled to at least a portion of a power cable externally extending from the electrical product main body

### BACKGROUND OF THE INVENTION

1. Field of the Invention

The present invention relates to electrical products and, more particularly, to an electrical product capable of preferably using wireless communication such as in a radio frequency identification (RFID) system.

2. Description of the Related Art

Hitherto, RFID systems have been developed as article management systems. In such an RFID system, a reader-writer producing an electromagnetic field communicates with an RFID tag (wireless integrated circuit (IC) device) in a non-contact manner to transmit information. The RFID tag is attached to an article and stores certain information. Japanese Unexamined Patent Application Publication No. 2002-143826 and Japanese Unexamined Patent Application Publication No. 2003-308363 disclose examples in which RFID tags are used for recycle management of home electric appliances. However, since a tag is attached on a control board incorporated in the door of a refrigerator in a recycle system described in Japanese Unexamined Patent Application Publication No. 2002-143826, arrangement of a metal material around the tag can possibly inhibit stable communication with a reader writer. The mounting mode of the tag is not mentioned in Japanese Unexamined Patent Application Publication No. 2003-308363.

In contrast, Japanese Unexamined Patent Application Publication No. 2005-50581 discloses an example in which an RFID tag is attached on a power line or a plug and part of the power line is used as an antenna. However, when management is performed with the power cord being attached on a product, it is not possible to perform the management if the cord is pulled out from the product. It is not preferred to attach the tag on the cord in the light of repair or replacement of the cord when the cord is fixed to the product.

### SUMMARY OF THE INVENTION

Preferred embodiments of the present invention provide an electrical product that stably and reliably communicates with a reader-writer and prevents its wireless IC device from, for example, being damaged or detached.

An electrical product according to a preferred embodiment of the present invention includes a wireless IC device that processes a high-frequency signal arranged in a main body of the electrical product, and an input-output terminal of the wireless IC device is coupled to at least a portion of a power cable externally extending from the main body of the electrical product.

In the above electrical product, the power cable to which the wireless IC device is coupled defines and functions as a monopole antenna or a dipole antenna to establish wireless communication with a reader-writer in order to manage, for example, a recycling and/or a life cycle of the electrical product. Since the power cable externally extending from the electrical product defines and functions as an antenna, stable and reliable communication is achieved without causing a problem in the wireless communication even if a metal material is arranged adjacent to the wireless IC device or a cover of the electrical product is made of a metal. In addition, since the wireless IC device is preferably arranged inside the main body of the electrical product, the wireless IC device is not damaged or detached due to, for example, an external impact.

According to various preferred embodiments of the present invention, it is possible to establish the stable wireless communication and to prevent the wireless IC device from, for example, being damaged or detached.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a descriptive diagram showing the relationship between an electrical product according to a first preferred embodiment of the present invention and a communication system.

FIG. 2 is a descriptive diagram showing an arrangement of a wireless IC device in the electrical product of the first preferred embodiment of the present invention.

FIG. 3 is a descriptive diagram concerning a main portion in FIG. 2.

FIGS. 4A and 4B are descriptive diagrams showing other examples of the arrangement of the wireless IC device.

FIG. 5 is a descriptive diagram showing another example of the wireless IC device.

FIG. 6 is a descriptive diagram showing the relationship between an electrical product of a second preferred embodiment of the present invention and a communication system.

FIG. 7 is a descriptive diagram showing an arrangement of a wireless IC device in the electrical product of the second preferred embodiment of the present invention.

FIG. 8 is a descriptive diagram showing the relationship between an electrical product of a third preferred embodiment of the present invention and a communication system.

FIG. 9 is a descriptive diagram showing an arrangement of a wireless IC device in the electrical product of the third preferred embodiment of the present invention.

### DETAILED DESCRIPTION OF THE PREFERRED EMBODIMENTS

Electrical products according to preferred embodiments of the present invention will herein be described with reference to the attached drawings. The common reference numerals are used in each drawing to identify the same components and portions. A description of such components and portions is omitted herein.

### First Preferred Embodiment

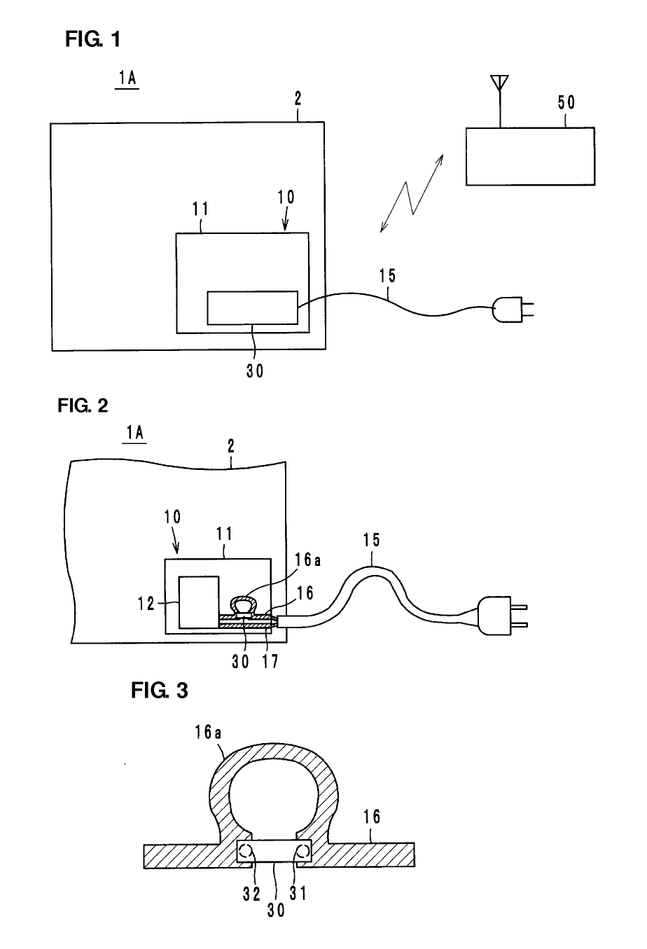

In an electrical product 1A according to a first preferred embodiment of the present invention, as shown in FIG. 1, a wireless IC device 30 is preferably installed on a board 11 of a power supply unit 10 incorporated in a product main body 2 made of, for example, a metal and the wireless IC device 30 is (directly or indirectly) coupled to at least a portion of a power cable 15 externally extending from the product main body 2. The power cable 15 defines and functions as an antenna for the wireless IC device 30 to perform wireless communication with a reader-writer 50 in an RFID system in a certain frequency band. The “coupling” in this description includes any of direct electrical coupling, magnetic field coupling, electric field coupling, and electromagnetic field coupling.

Specifically, as shown in FIG. 2, the power board 11 includes conductor patterns 16 and 17 located thereon, in addition to a power supply unit 12. The conductor patterns and 17 are connected to the power cable 15. A loop conductor 16a is preferably located in an intermediate portion of the conductor pattern 16, as shown in FIG. 3. Input-output terminals 31 and 32 of the wireless IC device 30 are coupled to both ends of the loop conductor 16a. The loop conductor 16a has a function to match the impedance with the wireless IC device 30 in accordance with its line length.

The wireless IC device 30 is an RFID tag and preferably includes a processing circuit (including a central processing unit (CPU) and a rewritable memory) that processes a high-frequency signal. A combination of a wireless IC chip and a feed circuit board including a feed circuit coupled to the wireless IC chip may be used as the wireless IC device 30, for example.

In the above configuration, the input-output terminals 31 and 32 of the wireless IC device 30 are coupled to the loop conductor 16a to transmit power and a high-frequency signal, the loop conductor 16a is coupled to one of the conductors of the power cable 15 via the conductor pattern 16, and the power cable 15 defines and functions as a monopole antenna. Accordingly, it is possible to establish the communication between the wireless IC device 30 and the external reader-writer 50 via the power cable 15. The communication between the wireless IC device 30 and the external reader-writer 50 via the power cable 15 is available even in a state in which the power cable 15 is pulled out from an outlet.

Since the power cable 15 externally extending from the electrical product 1A defines and functions as an antenna in the first preferred embodiment, stable and reliable communication is available without causing a problem in the wireless communication even if a metal material is arranged adjacent to the wireless IC device 30 or a cover of the electrical product is made of a metal. In addition, since the wireless IC device 30 is arranged inside the product main body 2, the wireless IC device 30 is not damaged or detached due to, for example, an external impact. Furthermore, since the wireless IC device 30 is coupled to one conductor of the power cable 15, the power voltage applied to the input-output terminals 31 and 32 is very small and, thus, the wireless IC device 30 is not damaged by the application of the voltage.

The power board 11 may be a multilayer board and the conductor patterns 16 and 17 and the loop conductor 16a may be incorporated in the board 11 when the board 11 is a multilayer board. The wireless IC device 30 may be incorporated in the board 11.

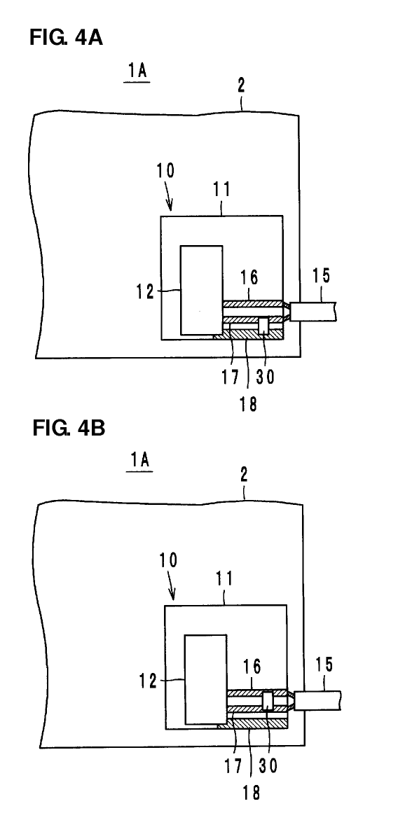

Modifications of the arrangement of the wireless IC device 30 in the first preferred embodiment of the present invention are shown in FIGS. 4A and 4B. In a first modification shown in FIG. 4A, the conductor patterns 16 and 17 and a ground pattern 18 are located on the power board 11 and the wireless IC device 30 is coupled to the conductor pattern 17 and the ground pattern 18. In this case, one conductor of the power cable 15 connected to the conductor pattern 17 defines and functions as a monopole antenna. In a second modification shown in FIG. 4B, the wireless IC device 30 is coupled to the conductor patterns 16 and 17. In this case, both of the conductors of the power cable 15 connected to the conductor patterns 16 and 17 define and function as a dipole antenna.

Since the loop conductor 16a is not required in the first and second modifications described above, unlike the first preferred embodiment, it is possible to reduce the area where the wireless IC device 30 is installed.

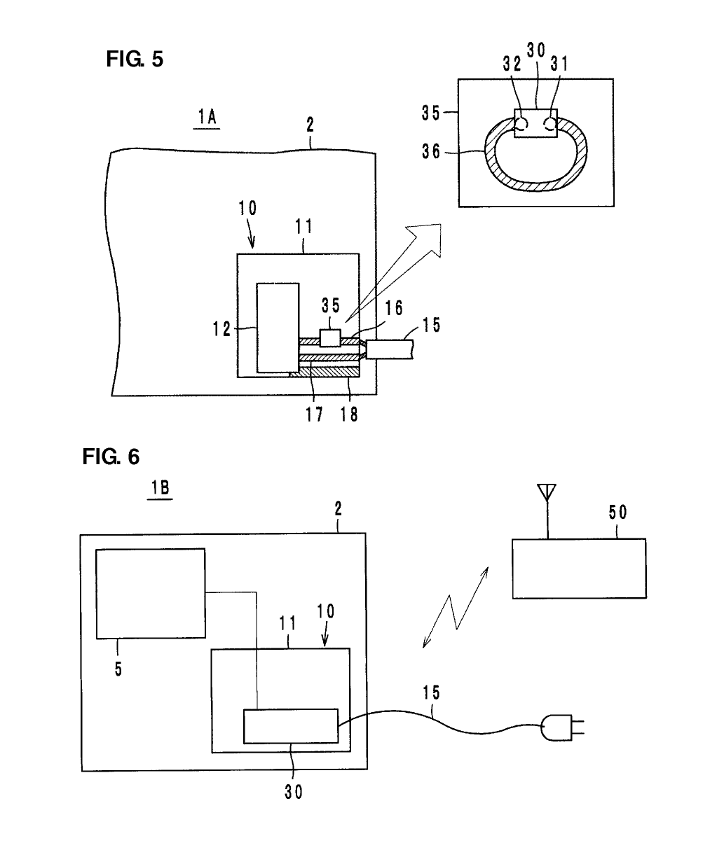

In a third modification shown in FIG. 5, a loop conductor 36 to provide impedance matching is located on a child board 35 and the wireless IC device 30 is coupled to both ends of the loop conductor 36. The child board 35 is installed on the conductor pattern 16 located on the power board 11 and, thus, the loop conductor 36 is coupled to the conductor pattern 16. In other words, the wireless IC device 30 is coupled to the loop conductor 36 and the loop conductor 36 is coupled to the power cable 15 via the conductor pattern 16. Accordingly, one of the conductors of the power cable 15 defines and functions as a monopole antenna. According to the third modification, the installation of the child board 35 on the power supply unit 10 allows even an electrical product on which the wireless IC device 30 is not planned to be installed to be incorporated in an RFID system. In addition, for example, no power voltage or no external electrostatic input is directly applied to the wireless IC device 30 and, thus, it is possible to reduce the risk of breaking the wireless IC device 30.

### Second Preferred Embodiment

In an electrical product 1B according to a second preferred embodiment of the present invention, as shown in FIG. 6, the wireless IC device 30 is installed on the power board 11, is (directly or indirectly) coupled to at least a portion of the power cable 15, and is connected to a main body control circuit 5 of the electrical product 1B.

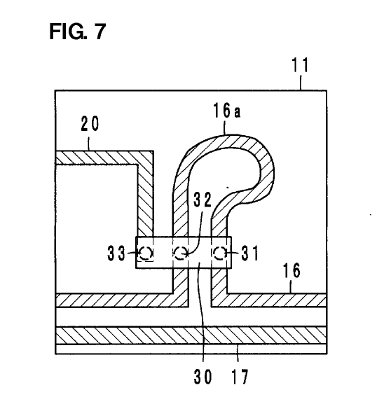

Specifically, as shown in FIG. 7, the conductor patterns 16 and 17 connected to the power cable 15 and a conductor pattern 20 connected to the main body control circuit 5 are located on the power board 11, and the loop conductor 16a is located in the conductor pattern 16. The wireless IC device 30 includes a first terminal 31, a second terminal 32, and a third terminal 33. The first and second terminals 31 and 32 are coupled to the conductor pattern 16 (a bottom portion of the loop conductor 16a). In addition, the third terminal 33 is coupled to an end of the conductor pattern 20. The conductor patterns 16 and 17 are connected to the power supply unit 12 (refer to FIG. 2).

In the above configuration, the first and second terminals 31 and 32 of the wireless IC device 30 are coupled to the loop conductor 16a to transmit power and a high-frequency signal, the loop conductor 16a is coupled to one of the conductors of the power cable 15 via the conductor pattern 16, and the power cable 15 defines and functions as a monopole antenna. Accordingly, it is possible to establish the communication between the wireless IC device 30 and the external reader-writer 50 via the power cable 15. In addition, it is possible to transmit necessary information to the main body control circuit 5 in a wired manner via the second and third terminals 32 and 33 of the wireless IC device 30. Although the terminal 32 and the conductor pattern 16 define and serve as terminals defining a ground potential for an information signal to be transmitted in the wired manner, the ground potential terminal is not limited to the above one. Another ground terminal may be additionally provided in the wireless IC device 30 and the terminal may be connected to the ground pattern on the board.

In the second preferred embodiment, in addition to the functions of the above first preferred embodiment, necessary information is transmitted from the reader-writer 50 to the wireless IC device 30, for example, even when the electrical product main body 2 is turned off, the information is stored in the memory of the wireless IC device 30, and the information is transmitted from the wireless IC device 30 to the main body control circuit 5 when the main body 2 is turned on to allow a necessary instruction to be issued to the electrical product 1B.

### Third Preferred Embodiment

In an electrical product 1C according to a third preferred embodiment of the present invention, as shown in

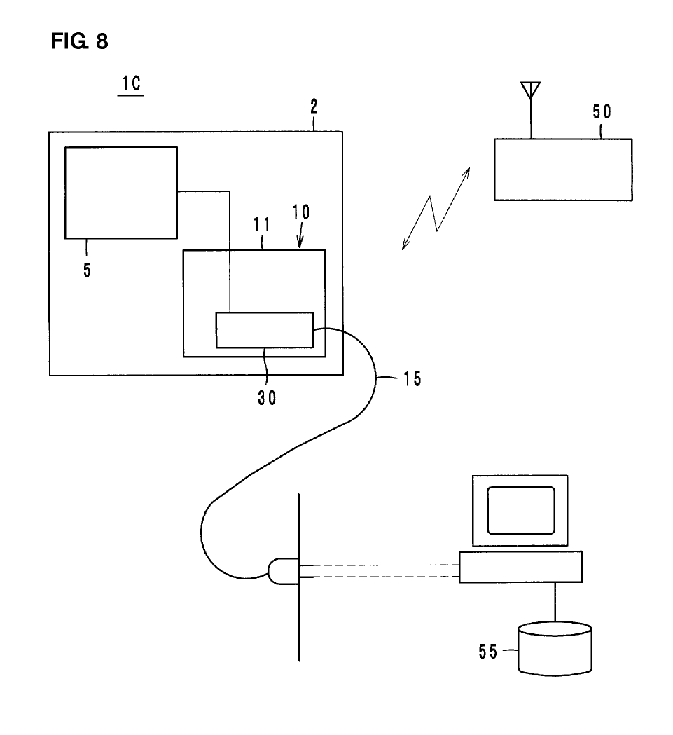

FIG. 8, the wireless IC device 30 is installed on the power board 11, the wireless IC device 30 is (directly or indirectly) coupled to at least a portion of the power cable 15, the wireless IC device 30 is connected to the main body control circuit 5 in the electrical product 1C, and power line communication with a server 55 is available via the power cable 15.

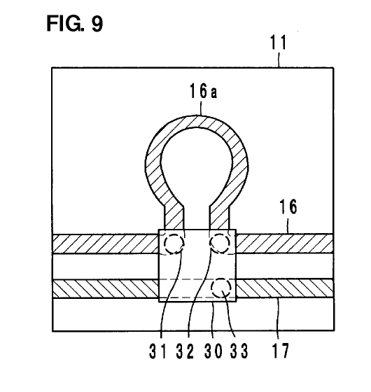

Specifically, as shown in FIG. 9, the conductor patterns 16 and 17 connected to the power cable 15 are located on the power board 11, and the loop conductor 16a is located in the conductor pattern 16. The wireless IC device 30 includes the first terminal 31, the second terminal 32, and the third terminal 33. The first and second terminals 31 and 32 are coupled to the conductor pattern 16 (e.g., a bottom portion of the loop conductor 16a). In addition, the third terminal 33 is coupled to the conductor pattern 17. The conductor patterns 16 and 17 branch off into two to be connected to the power supply unit 12 (refer to FIG. 2) and the main body control circuit 5.

In the above configuration, the first and second terminals 31 and 32 of the wireless IC device 30 are coupled to the loop conductor 16a to transmit power and a high-frequency signal, the loop conductor 16a is coupled to one of the conductors of the power cable 15 via the conductor pattern 16, and the power cable 15 defines and functions as a monopole antenna. Accordingly, it is possible to establish the communication between the wireless IC device 30 and the external reader-writer 50 via the power cable 15. In addition, the power line communication with the server 55 is available through the second and third terminals 32 and 33 of the wireless IC device 30 and via the power cable 15.

In the third preferred embodiment, in addition to the functions of the above first preferred embodiment, for example, the server 55 is capable of acquiring information about the electrical product 1C by the power line communication and transmitting information and/or an instruction to the wireless IC device 30. The communication of this type is available even when the electrical product 1C is turned off. The server 55 normally manages multiple electrical products.

### Other Preferred Embodiments

The electrical products according to the present invention are not limited to the preferred embodiments described above and it will be clear that various modifications can be made within the spirit and scope of the present invention.

For example, electrical products, such as refrigerators, from which power cables extend, are targeted and preferred embodiments of the present invention are widely applicable to various electrical products. The power supply unit and the board thereof may have arbitrary configurations. The power cable may not be fixed to the power board side and may be detachably connected via a connector provided on the power board. An alternating current (AC) adapter may be configured as an external unit and the power board may receive direct current (DC).

As described above, preferred embodiments of the present invention are useful for electrical products. In particular, preferred embodiments of the present invention are excellent in that the stable and reliable wireless communication is achieved and the wireless IC device can be prevented from, for example, being damaged or detached.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electrical product comprising:
a main body;
a wireless IC device that processes a high-frequency signal and is arranged in the main body of the electrical product; wherein
an input-output terminal of the wireless IC device is coupled to at least a portion of a power cable externally extending from the main body of the electrical product.

2. The electrical product according to claim 1, wherein the wireless IC device is installed on a surface or in a first board on which a power supply circuit is installed.

3. The electrical product according to claim 2, wherein a conductor pattern connected to the power cable is located on the first board, and a loop conductor that provides impedance matching with the wireless IC device is located in at least a portion of the conductor pattern, and the wireless IC device is coupled to the loop conductor.

4. The electrical product according to claim 1, wherein a loop conductor that provides impedance matching with the wireless IC device is located on a second board, the wireless IC device is coupled to the loop conductor, and the loop conductor is coupled to at least a portion of the power cable.

5. The electrical product according to claim 4, wherein a conductor pattern connected to the power cable is located on a first board on which a power supply circuit is installed, and the second board is installed on the first board and the loop conductor is coupled to the conductor pattern.

6. The electrical product according to claim 1, wherein the wireless IC device includes a second input-output terminal other than a first input-output terminal directly or indirectly coupled to the power cable, and the second input-output terminal is connected to a control circuit of the main body of the electrical product via a communication wire.

7. The electrical product according to claim 1, wherein the wireless IC device includes a second input-output terminal other than a first input-output terminal directly or indirectly coupled to the power cable, and the second input-output terminal defines and functions as a terminal for power line communication via the power cable.

8. The electrical product according to claim 1, wherein the coupling between the wireless IC device and the power cable, the conductor pattern, or the loop conductor or the coupling between the loop conductor and the power cable or the conductor pattern is at least one of direct electrical coupling, magnetic field coupling, electric field coupling, and electromagnetic field coupling.

9. The electrical product according to claim 1, wherein the main body is made of metal.

10. The electrical product according to claim 1, wherein the power cable defines and functions as an antenna for the wireless IC device.

11. The electrical product according to claim 1, wherein the antenna is arranged to perform wireless communication with a reader-writer in an RFID system.

12. The electrical product according to claim 1, wherein the wireless IC device is an RFID tag including a processing circuit that processes a high-frequency signal.

13. The electrical product according to claim 1, wherein the wireless IC device includes a wireless IC chip and a feed circuit board including a feed circuit coupled to the wireless IC chip.

14. The electrical product according to claim 1, wherein the input-output terminal of the wireless IC device is coupled to a loop conductor to transmit power and a high-frequency signal, the loop conductor is coupled to a conductor of the power cable, and the power cable defines and functions as a monopole antenna.

15. The electrical product according to claim 1, further comprising a power board including a conductor pattern and a ground pattern are located thereon, wherein the wireless IC device is coupled to the conductor pattern and the ground pattern.

16. The electrical product according to claim 15, wherein one conductor of the power cable that is connected to the conductor pattern defines and functions as a monopole antenna.

17. The electrical product according to claim 1, further comprising a power board including at least two conductor patterns, wherein the wireless IC device is coupled to the at least two conductor patterns.

18. The electrical product according to claim 17, wherein the wireless IC device is connected to the at least two conductor patterns, and two conductors of the power cable that are connected to the at least two conductor patterns define and function as a monopole antenna.

19. The electrical product according to claim 1, further comprising a power board, a child board, and a loop conductor that provides impedance matching and is located on the child board, wherein the wireless IC device is coupled to both ends of the loop conductor, and the child board is located on a conductor pattern located on the power board so as to connect the loop conductor to the conductor pattern.

20. A radio frequency identification system comprising the electrical product according to claim 1.
